(19) United States
(12) Patent Application Publication
(10) Pub. No.: US 2005/0278943 A1
(43) Pub. Date: Dec. 22, 2005

(54) Component placement apparatus and method

(75) Inventor: Adrianus Johannes Petrus Maria Vermeer, BW Geldrop (NL)

Correspondence Address: FOLEY AND LARDNER LLP;SUITE 500, 3000 K STREET NW, WASHINGTON, DC, 20007, US

(73) Assignee: Assembleon N.V.

(21) Appl. No.: 11/134,515

(22) Filed: May 23, 2005

(30) Foreign Application Priority Data
Jun. 11, 2004 (EP) 04102655.0

(51) Int. Cl. B23P 19/00

(52) U.S. Cl. 29/740; 29/742; 29/834

(57) ABSTRACT

A component placement apparatus includes: a tray storing device for storing at least one tray that contains, e.g., components; a buffer on which components picked-up from the tray, by means of a first component pickup and placement device, may be temporarily stored; and a second pickup and place device for picking-up a component from the buffer and placing the component on a substrate.

### CROSS-REFERENCE TO RELATED APPLICATIONS

This application claims priority to EP 04102655.0, which was filed on Jun. 11, 2004 and which is incorporated by reference herein in its entirety.

### BACKGROUND

A conventional component placement device (and its associated method of use) is described in European Patent Application No. EP 0 883 333 (“the '333 Application”). The component placement apparatus according to the '333 Application includes a component feeding device in which a carriage, which includes several slots for trays that contain electronic components, is movable in upward and downward directions. The component feeding device includes a tray transporting device by means of which a tray located in a slot is movable in a horizontal direction to a pickup area. By means of a component pickup and placement device, a component is picked-up from the tray in the pickup area and is transported to a desired location on a substrate. After one or more components are picked-up from the tray, the tray is placed back in the same slot and the carriage is subsequently moved in a vertical direction to align another slot (that includes another tray) with the tray transporting device.

A disadvantage of this conventional component placement apparatus is that when a tray is exchanged with another tray that contains a different kind of component (or when an empty tray is exchanged for a full tray), no component can be taken from the tray and placed on the substrate.

What is needed, therefore, is an apparatus and a methodology that address at least one if not more of the deficiencies that afflict conventional practice, as previously described.

### SUMMARY

The invention relates to a component placement apparatus that includes a tray storing device for storing at least one tray that contains, e.g., electronic components and at least one component pickup and placement device. The invention furthermore relates to a method for operating a component feeding device that includes a tray storing device for storing at least one tray that contains, e.g., electronic components and at least one component pickup and placement device.

An object of the invention to provide a component placement apparatus with a higher output. This object can be achieved by the component placement apparatus according to the present invention. An embodiment of the component placement apparatus includes, among other possible things: a buffer on which components picked-up from the tray, by means of a first component pickup and placement device, may be temporarily stored; and a second pickup and placement device for picking-up a component from the buffer and placing the component on a substrate.

Due to the buffer, components stored on the buffer can be placed, by means of the second pickup and placement device, on the substrate while a tray exchange concurrently occurs. As soon as the desired tray is available in a pickup area, components will be transferred by means of the first pickup and placement device from the tray to the buffer.

While components are transferred from the tray to the buffer, by means of the first pickup and placement device, components available in the component placement apparatus (by other means like tape feeders, stick feeder, bulk feeders, etc.) can be picked-up and placed on the substrate by means of the second pickup and placement device.

According to an embodiment of the component placement apparatus according to the invention, the buffer may include at least one component pickup position in a pickup area on which a component can be temporarily stored. In instances in which the buffer includes only one component pickup position, it may be aligned with pickup locations of other component feeding devices; the positions on which the second component pickup and placement device may pick-up a component may be well defined. In contrast, in instances where the buffer includes several component pickup positions, the positions may be located in one or more rows or may be placed randomly in a well-defined area.

According to another embodiment of the component placement apparatus according to the invention, the component placement apparatus may include a number of tape feeders each of which includes a component pickup location. The component pickup locations may be aligned with the at least one component pickup position of the buffer. Moreover, if the component pickup position and the component pickup locations are aligned with each other, there will be no differences for the second pickup and placement device between picking-up components from component pickup locations or pickup positions.

According to another embodiment of the component placement apparatus according to the invention, the buffer may include a matrix of component pickup positions on which components can be temporarily stored. In this manner the buffer may include a relatively large number of components that are located in a matrix of component pickup positions. As the components are located in a matrix, the distances between the component pickup positions and the substrate may be relatively small and be well defined with respect to each other.

According to another embodiment of the component placement apparatus according to the invention, components may be temporarily stored at random positions on a pickup area of the buffer. As a result, flexible use may be made of the entire space of the pickup area. Accordingly, dependent on the size of different components, maximum efficiency of the space on the buffer may be achieved such that a minimum distance between the pickup positions may be obtained.

According to another embodiment of the component placement apparatus according to the invention, the component placement apparatus may include a controller that is configured to: (a) allocate the components to a specific position on the buffer; and/or (b) control the movement of the pickup and placement devices to place a component on, and pick-up a component from, the correct position on the buffer. With such a controller, optimized use of the pickup area of the buffer may be achieved.

According to a further embodiment of the component placement apparatus according to the invention, the controller may include a collision prevention means configured to prevent a collision between the pickup and placement devices. Such a controller can greatly reduce the likelihood that a component is placed on the buffer by the first pickup and placement device while another component is picked-up by the second pickup and placement device.

According to another embodiment of the component placement apparatus according to the invention, the buffer may include at least one endless belt on which at least one component may be temporarily stored while the component is moved, by means of the endless belt, from a position closer to the tray to a position closer to the substrate. With such an endless belt, the distances between picking-up a component and placing the component can be relatively small for both the first and second component pickup and placement devices.

These and other features, aspects, and advantages of the present invention will become more apparent from the following description, appended claims, and accompanying exemplary embodiments shown in the drawings.

### BRIEF DESCRIPTION OF THE DRAWINGS

FIG. 1 is a top view of a component placement apparatus according to the invention;

FIG. 2 is a perspective view of a component feeding device according to the present invention, which component feeding device is used in the component placement device shown in FIG. 1;

FIG. 3 is a top view of the component feeding device shown in FIG. 2 wherein the component feeding device is incorporated in a trolley for feeding components in trays and/or tapes;

FIG. 4 is a perspective views of a second embodiment of a component placement device according to the present invention;

FIG. 5 is a perspective views of a third embodiment of a component placement device according to the present invention; and

FIG. 6 is a perspective views of a fourth embodiment of a component placement device according to the present invention.

### DETAILED DESCRIPTION

Presently preferred embodiments of the invention are illustrated in the drawings. An effort has been made to use the same, or like, reference numbers throughout the drawings to refer to the same or like parts.

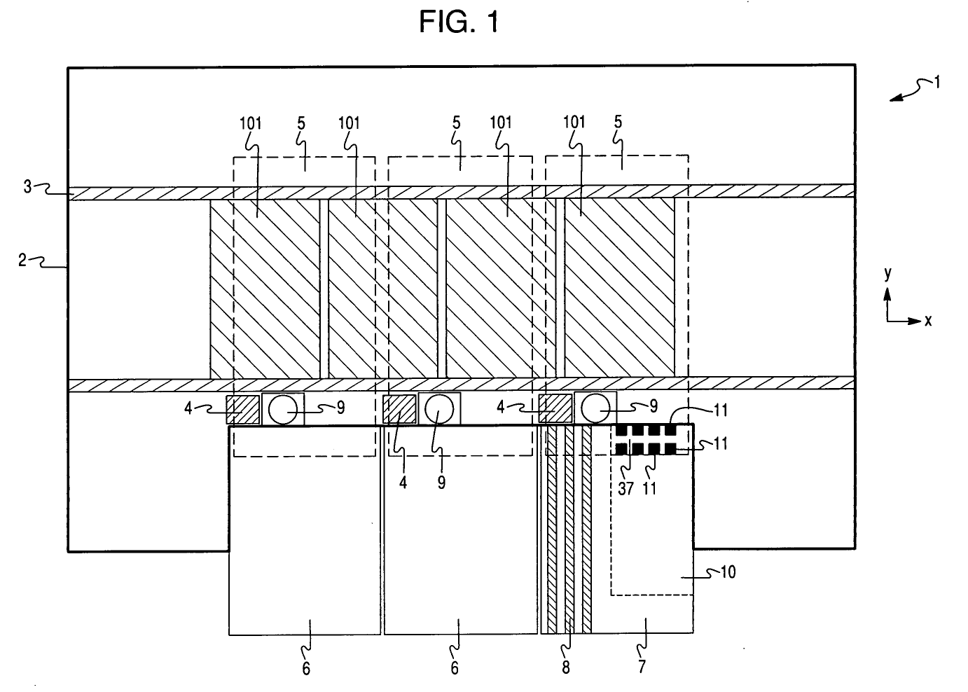

FIG. 1 shows a top view of a component placement apparatus 1 according to the invention. The component placement apparatus includes a frame 2 in which a transport device 3 for transporting substrates is accommodated. The transport device 3 is indexed over a certain distance in the positive X-direction by means which the transport device 3 may be moved back into its starting position in the negative X-direction after the distance has been covered. Substrates 101, e.g., printed circuit boards, can be transported through the component placement apparatus 1 by the transport device 3.

The component placement apparatus 1 is furthermore provided with, e.g., three pickup and placement devices 4 that are provided with a vacuum tube (or other pickup member). The pickup and placement devices 4 are movable in an area 5 that is indicated by dotted lines. Specifically, the pickup and placement devices 4 are movable in, and opposite to, the X-direction as well as in, an opposite, to the Y-direction.

A trolley 6 is provided proximal each pickup and placement device 4. Each trolley 6 is provided with a number of reels 8 that may be provided with, e.g., tapes in which, e.g., components may be stored. By means of a pickup and placement device 4, components may successively be picked-up from one of the reels 8. Subsequently, the position of the component with respect to the pickup and placement device 4 may be detected by means of a component alignment device 9. Subsequently still, the component may be placed on a desired location on the substrate 101 located in the respective area 5 of the pickup and placement device 4. Such a trolley 6 (as well as the reels 8) are conventionally known and, therefore, will not be further described.

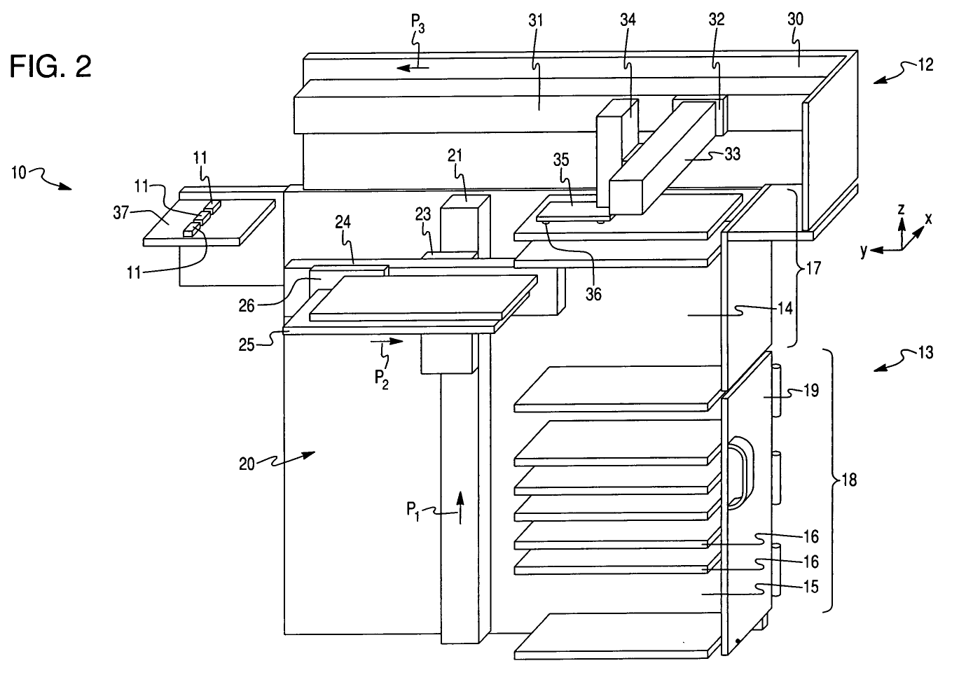

Another trolley 7 also includes reels 8. This second trolley 7, however, also includes a component feeding apparatus 10. As will be explained with reference to the FIGS. 2-6, components 11, which are stored on trays 16 in the component feeding apparatus 10, may be presented into the area 5 of each pickup and placement device 4.

FIG. 2 shows a perspective view of the component feeding device 10, which includes an upper part 12 and a lower part 13. The lower part 13 includes a tray storing device 14 having a number of slots 15 for storing stacked trays 16 that contain, e.g., electronic components. The slots 15 in an upper portion 17 of the tray storing device 14 are only accessible from the interior of the tray storing device 14 whereas the slots 15 in a lower portion 18 of the tray storing device 14 are accessible from both the interior and the exterior (by means of a door 19). The lower part 13 furthermore includes a tray transporting device 20. The tray transporting device 20 has a vertical column 21 along which a guide 23 is movable in, and opposite to, a direction indicated by arrow P₁, parallel to the Z-direction. Attached to the guide 23 is a horizontally extending beam 24 and a horizontally extending platform 25. To move a tray 16 into and out of a slot 15, a gripping device 26 is movable along the beam 24 in, and opposite to, a direction indicated by arrow P₂, parallel to the Y-direction.

The upper part 12 of the component feeding device 10 includes a frame 30 provided with a beam 31 that extends in the Y-direction. A guide 32 is movable along the beam 31 in, and opposite to, a direction indicated by arrow P₃, parallel to the Y-direction. Attached to the guide 32 is a beam 33 that extends parallel to the X-direction along which a guide 34 is movable in, and opposite to, a direction indicated by arrow P₄. Attached to the guide 34 is a plate 35 that carries a pickup and placement device 36, e.g., a vacuum nozzle or a gripper. The upper part 12 furthermore includes a buffer 37 on which components 11 are presented to the pickup and placement device 4 of the component placement apparatus 1.

The operation of the component feeding device 10 according to the invention will now be explained. If no trays 16 are located in the slots 15, an operator will open door 19 and insert trays 16 in the slots 15 of the second part 18 of the tray storing device 14. Typically, each tray 16 will contain a different component. However, if one particular component is expected to be needed in a relatively large amount, it is possible to insert multiple trays 16 that contain the same component.

One or both of the component placement apparatus 1 and the component feeding device 10 includes a controller in which information is loaded about which kind of component needs to be placed (by a specific pickup and placement device 4) at each position on a substrate. From this information, the controller determines which components 11 need to be available on the buffer 37 in the short term. Subsequently, the platform 25 is moved, by means of the guide 23, along the vertical column 21 in, or opposite to, the direction indicated by arrow P₁, until it is aligned with a slot 15 in which a tray 16 that contains the necessary component(s) is located.

By means of the gripping device 26, the tray 16 is removed from the slot 15 and moved onto the platform 25. The tray 16 is then moved upwardly on the platform 25 until the tray 16 is located in the same horizontal X, Y-plane as the buffer 37; when in the X, Y-plane of the buffer 37, the tray 16 is considered to be in the pickup area of the component feeding apparatus 10. When the tray 16 is in the pickup area, the pickup and placement device 36 is moved, by means of the guides 32, 34, in, and opposite to, the directions indicated by the arrows P₃, P₄, respectively, to pick-up a component 11 from the tray 16 and to place this component 11 on a desired location on the buffer 37.

The controller subsequently determines whether the tray 16 will be needed again in short term. If, in very short term, additional components 11 from the tray 16, which is present in the pickup area, will be needed, these components 11 may also be placed on the buffer 37. Similarly, if the controller determines that the tray 16 will be needed at the pickup area in the short term, the tray 16 may be transported, by means of the tray transporting device 20, to an empty slot 15 in the first part 17 of the tray storing device 14. If, however, the controller determines that the tray 16 is empty or that the tray 16 will not be needed at the pickup area in the short term, the tray 16 may be transported, by means of the tray transporting device 20, to an empty slot 15 in the second part 18 of the tray storing device 14.

In this manner, the controller may direct the pickup and placement device 36 to place as many components 11 on the buffer forming substrate 37 as there are positions available. These components 11 will be picked-up by the pickup and placement device 4 and placed on a desired location on a substrate in the area 5.

If, in the interim, no trays 16 need to be presented at the pickup area, the controller may determine whether the trays 16 are in an optimized sequence such that, when eventually needed, the trays 16 may be presented as soon as possible to the pickup area. If the controller determines that there is a tray 16 in the first part 17, which is not expected to be needed in the short term at the pickup area, this tray 17 may be moved by means of the tray transporting device 20 in the manner previous described to a slot 15 in the second part 18 of the tray storing device 14. Similarly, a tray 16 in the second part 18, which the controller determines is expected to be needed at the pickup area in the short term, may be transferred to a slot 15 the first part 17 of the tray storing device 14.

It is also possible to optimize the sequence of the trays in both the first and second parts 17, 18 (by means of the controller). For example, it is possible to optimize the sequence of the trays 16 in the first part 17, thereby further reducing the time necessary to present a tray 16 at the pickup area. Similarly, it is possible to optimize the sequence of trays in the second part 18 so that, e.g., all empty trays 16 are located in the slots 15 that are most distal from the pickup area whereas the trays 16 with at least some components 11 are stored in the slots 15 in the second part 18 that are proximal to the first part 17. In this manner, all except one of the trays 16 that contain the same kind of components 11 will be located in the second part 18. The remaining tray will be located in the first part 17 closer to the pickup area; if this tray 16 is emptied, it will be moved to the second part 18 and a full replacement tray 16 with the same kind of components 11 will be moved to the first part 17.

If an operator wants to replace empty trays with full trays 16, the operator may open the door 19. The opening of the door 19 will be detected by means of a switch (not shown) and this information will be transferred to the controller. As long as the door 19 is open, the tray transporting device 20 will be controlled so that it can only store trays 16 in the first part 17 and/or removed trays 16 therefrom. Correspondingly, the operator can only remove and/or replace trays in the second part 18, thereby substantially reducing the risk of interference between the tray transporting device 20 and the operator.

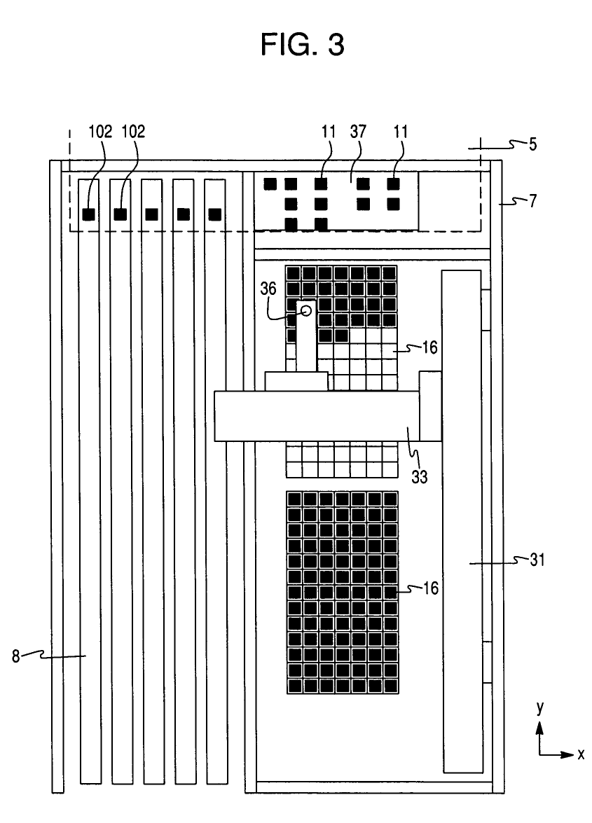

By the embodiment shown in FIGS. 1-3, the components 11 may be being placed in the buffer 37 in a matrix. In this manner, the positions of the components 11 may be well defined. Further, by means of the controller, it is relatively easy (a) to place the components 11 on the buffer 37 using the first pickup device 36 and (b) to pick-up the components 11 using the second pickup device 4. As can be seen in FIG. 3, component pickup locations 102 of the reels 8 of the tape feeders are aligned with each other but not necessarily with the component pickup positions of the components 11 on the buffer 37.

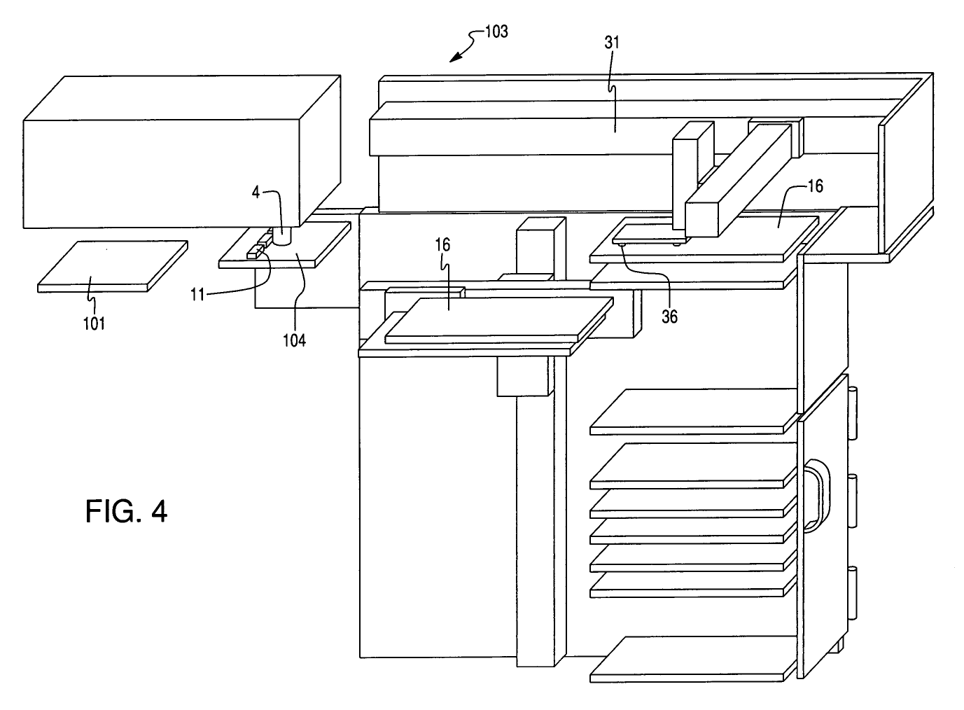

FIG. 4 shows a perspective view of a second embodiment of a component placement apparatus 103 according to the invention. In this embodiment, a buffer 104 includes, e.g., three aligned component pickup positions on which components 11 can be temporarily stored. The component pickup positions are also substantially aligned with the component pickup locations 102 (FIG. 3) and spaced apart over substantially the same distance as the component pickup locations 102. As a result, the controller of the component placement apparatus 103 encounters substantially no difference when picking-up components delivered to the component placement apparatus in reels 8 or in trays 16.

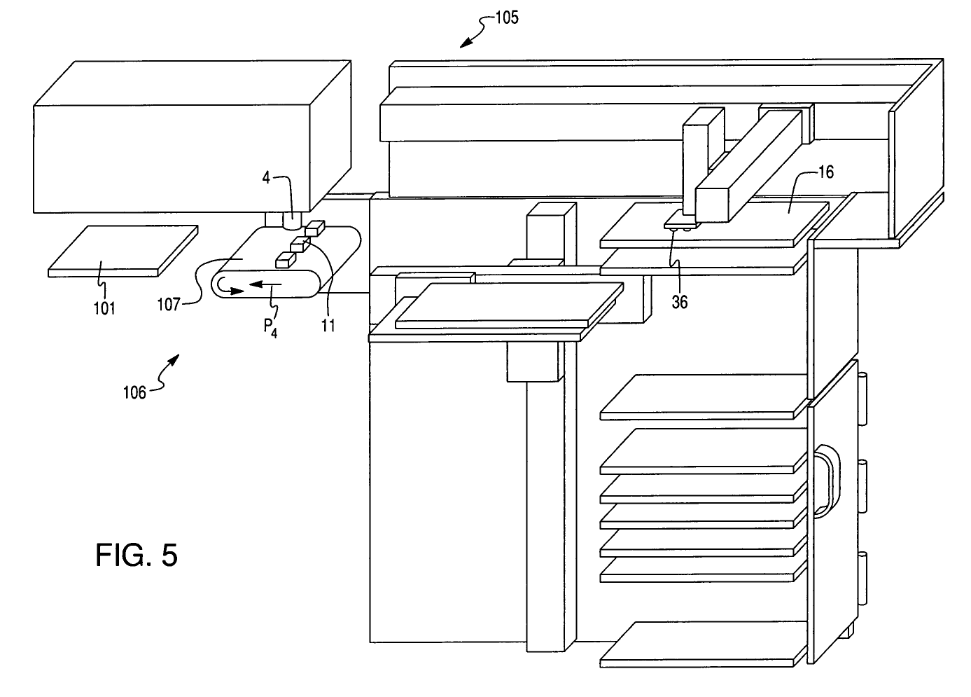

FIG. 5 shows a perspective view of a third embodiment of a component placement apparatus 105 according to the invention. In this embodiment, a buffer 106 includes an endless belt 107 that is driven by a motor (not shown) in a direction indicated by arrow P₄. A component 11 may be picked-up by the pickup and placement device 36 from the tray 16 and be placed on the belt 107 on a side proximal the tray 16. The belt 107 may be moved in the direction indicated by arrow P₄ so that the component 11 can be picked-up by the pickup and placement device 4 relatively close to the substrate 101 on which the component 11 needs to be placed. In this manner, it is possible to place a component on one side of the belt 107 while another component is concurrently picked-up from the belt 107.

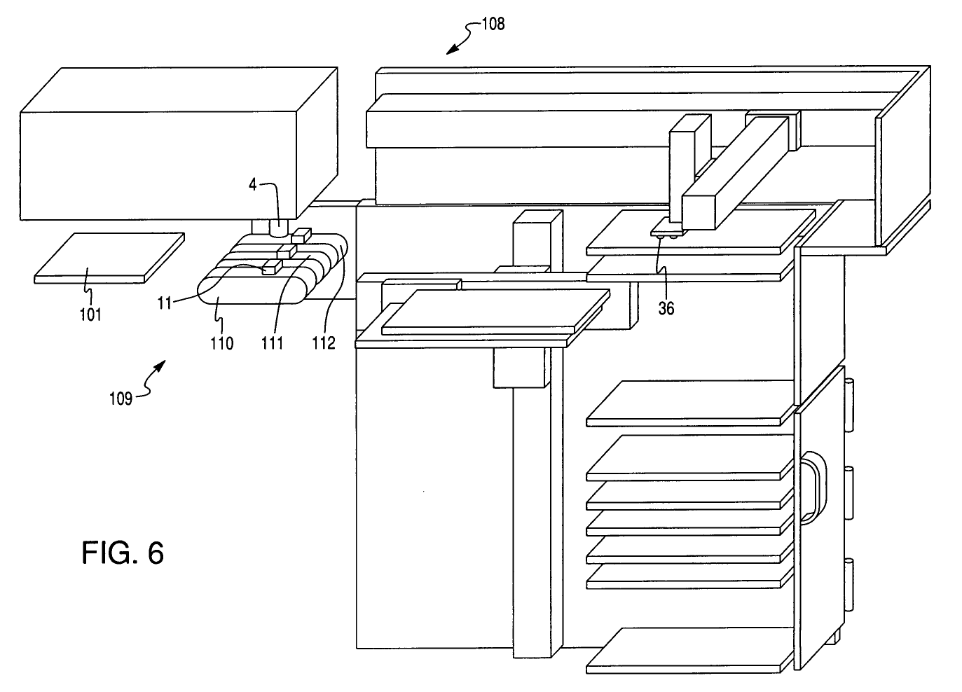

FIG. 6 shows a perspective view of a fourth embodiment of a component placement apparatus 108 according to the invention. In this embodiment, a buffer 109 includes, e.g., three independently driven belts 110, 111, 112 on which a plurality of components 11 can be temporarily stored. An advantage of the independently driven belts 110, 111, 112 is that, by means of each belt 110, 111, 112, a component may be presented relatively close to the substrate 101 while another component may be concurrently placed on the belt 110, 111, 112.

In each of the aforementioned embodiments, the controller may include a collision prevention means configured to prevent a collision between the pickup and placement devices 4, 36.

Although the tray transporting device may be moved along the slots 15, it is also possible for the tray storing device 14 to be moved up and down such that: (a) the trays that are needed in the short term may be located in the middle part of the tray storing device 14; (b) the trays that are emptied may be stored in the lower part of the tray storing device 14; and (c) the trays that are provided with components that are not expected to be needed in the short term may be located in the upper part of the tray storing device 14.

It is also possible to provide the tray storing device 14 with a third part, located on the left side of the vertical column 21 (FIG. 2) and below the transport device 3. Such a third part may be, e.g., filled with trays 16 in a manner similar to the first part 17. Moreover, trays 16, which are not expected to be needed in the short term, may be stored in such a third part.

It is also possible to use the tray storing device 14 to store stacks of trays 16, whereby a single tray 16 may be removed from the stack loaded in the upper part 17 whereas the remaining trays 16 of the stack may be stored in the lower part 18. Moreover, it is also possible to use the tray storing device 14 to store wafers carrying components.

Although the aforementioned describes embodiments of the invention, the invention is not so restricted. It will be apparent to those skilled in the art that various modifications and variations can be made to the disclosed embodiments of the present invention without departing from the scope or spirit of the invention. Accordingly, these other apparatuses and methods are fully within the scope of the claimed invention. Therefore, it should be understood that the apparatuses and methods described herein are illustrative only and are not limiting upon the scope of the invention, which is indicated by the following claims.

1. A component placement apparatus comprising:
a tray storing device that is configured to store at least one tray that is configured to contain one or more components;
a buffer;
a first component pickup and placement device that is configured to pick-up a component from the tray and to place the component on the buffer;
a second pickup and placement device that is configured to pick-up the component from the buffer and to place the component on a substrate.

2. The component placement apparatus according to claim 1, wherein the buffer includes at least one component pickup position in a pickup area at which the component can be temporarily stored.

3. The component placement apparatus according to claim 2, further comprising:
a plurality of tape feeders each of which includes a component pickup location,
wherein the component pickup locations are aligned with the at least one component pickup position of the buffer.

4. The component placement apparatus according to claim 1, wherein the buffer comprises a matrix of component pickup positions on which components can be temporarily stored.

5. The component placement apparatus according to claim 1, wherein the component placement apparatus is configured to store components temporarily at random positions on a pickup area of the buffer.

6. The component placement apparatus according to claim 1, further comprising:
a controller that is configured to allocate the components to specific positions on the buffer and to control the movement of the first and second pickup and placement devices to place a component on, and to pick-up a component from, a correct position on the buffer.

7. The component placement apparatus according to claim 6, wherein the controller comprises collision prevention means configured to prevent a collision between the first and second pickup and placement devices.

8. The component placement apparatus according to claim 1, wherein the buffer comprises at least one endless belt, wherein the component placement apparatus is configured to store at least one component temporarily on the endless belt, and wherein the endless belt is configured to move the component from a position proximal the tray to a position proximal the substrate.

9. A method for operating a component feeding device comprising a tray storing device that is configured to store at least one tray that is configured to contain one or more components, the method comprising the steps of:
picking-up, using a first pickup and placement device, a component from a tray in the tray storing device;
placing the component on a buffer;
storing the component temporarily on the buffer;
picking-up the component using a second pickup and placement device; and
placing the component on a desired location on a substrate.
